(19) United States
(12) Patent Application Publication
(10) Pub. No.: US 2018/0260797 A1
(43) Pub. Date: Sep. 13, 2018

(54) SYSTEM AND METHOD FOR PURCHASING AND PAYING FOR A PRODUCT OR SERVICE

(71) Applicant: MADA SERVICE DI CASSANI GIANCARLO E C. S.N.C.

(72) Inventor: Anastasio GURIOLI, Faenza (IT)

(73) Assignee: Mada Service di Cassani Giancarlo E.C. S.N.C., Conselice (Ravenna) (IT)

(21) Appl. No.: 15/746,879

(22) PCT Filed: Jul. 28, 2016
(86) PCT No.: PCT/IB2016/054503

§ 371 Date: Jan. 23, 2018

(30) Foreign Application Priority Data
Aug. 7, 2015 (IT) 102015000043370

(51) Int. Cl. G06Q 20/12; G06Q 30/06; G06Q 20/32; G06Q 20/20; G06Q 20/04

(52) U.S. Cl. CPC G06Q 20/12; G06Q 30/0641; G06Q 20/3278; G06Q 20/0453; G06Q 20/322; G06Q 20/209; G06Q 20/3274

(57) ABSTRACT

Systems and methods for purchasing and paying for a product or service are disclosed. Some embodiments of the methods include connecting a portable electronic device to a remote server having a database including descriptive data and price data. A product or service is selected from a list defined by the descriptive data and the price data. Payment for a selected product or service is submitted electronically through a remote communication between the portable electronic device and a virtual cash deposit. Purchase data representing the type and economic value of the selected product or service is generated by the server and transmitted to the portable electronic device. The generated purchase data is transferred from the portable electronic device to the printer via a wireless communication, and the printer processes the purchase data and generates a proof of purchase of the product or service in response.

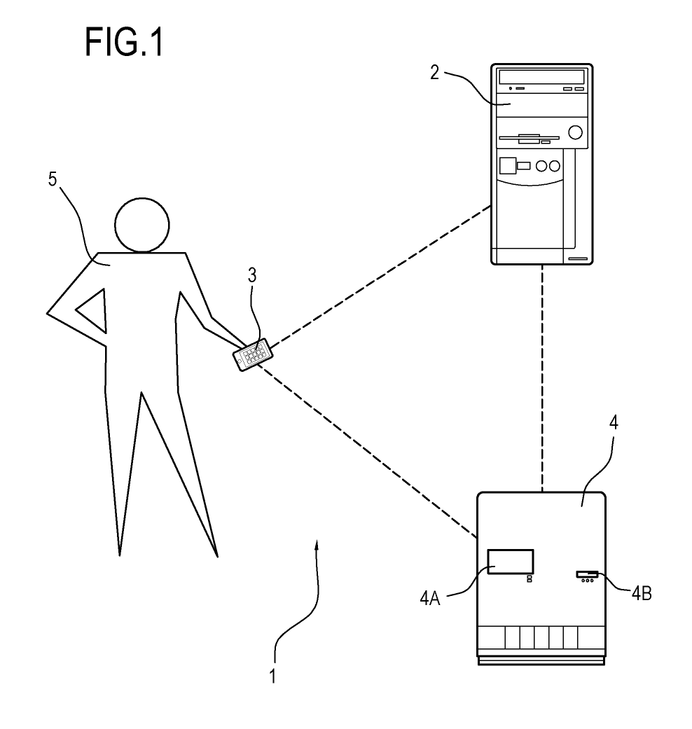

### TECHNICAL FIELD

This invention relates to a method and a system for purchasing and paying for a product or service.

The invention relates to the sector of trading in products or services. The invention applies to the e-commerce sector. More specifically, this invention is applicable particularly advantageously to the context of management of internet transactions between producer and consumer.

### BACKGROUND ART

Known in the prior art are businesses where a product or a service can be selected using a terminal comprising a computer, a screen (for example a touch screen) and an interface which allows a user to enter data. Typically, the terminal is programmed to display a payment screen (after a product has been selected) which allows payment for the product (or service) to be effected, for example using a debit card or a credit card. Typically, the terminal comprises a printer which is configured to print a payment receipt which entitles the user to receive the product or service paid for from personnel employed by the business.

This solution has considerable disadvantages. In some cases, the cost of the terminal is too high for the owner of the business. Furthermore, the procedure required to select and pay for the product may be slow and complicated (especially for inexpert users); this may lead to long queues and seemingly unending waiting.

### DISCLOSURE OF THE INVENTION

The aim of this invention is to provide a method and a system for purchasing and paying for a product or service to overcome the above mentioned disadvantages of the prior art.

More specifically, the aim of this invention is to provide a particularly quick and easy to use method and system for purchasing and paying for a product or service.

A further aim of the invention is to provide a particularly precise and dependable method and system for purchasing and paying for a product or service.

These aims are fully achieved by the system and method forming the object of this invention and as characterized in the appended claims.

The system comprises a server having a database which is accessible through a remote connection and which contains descriptive data representing at least one product or service, and price data representing an economic value of the at least one product or service.

The system comprises an electronic device having a processor, a screen and a data entry interface. The electronic device is configured to establish a wireless connection to the server. The electronic device is preferably portable (for example, a smartphone or a tablet). The electronic device is configured to access the database and to select at least one product or service.

The electronic device is configured to receive from the server purchase data representing the product and the economic value of the at least one selected product or service.

The system also comprises a printer which is equipped with a processor. Preferably, the printer comprises a screen and a data entry interface. The printer is configured to establish a wireless connection to the electronic device. Preferably, the printer is configured to establish a wireless connection to the server. Preferably, the printer is configured to print a proof of purchase relating to the at least one selected product or service. According to the invention, the printer is configured to receive the purchase data through a wireless connection to the portable device.

In an example embodiment, the wireless connection is one or more of the following options:
a Wi-Fi connection;
a Near-Field Communication connection;
a Bluetooth connection;
an infrared connection.

In a further example embodiment, the purchase data comprise an encrypted code. For example, the purchase data comprise a bar code or a QR code. The printer comprises an optical reader configured to recognize the encrypted code and to receive the purchase data.

In an example embodiment, the printer is configured to print a hard copy of the proof of purchase. In an example embodiment, the printer is configured to generate an alarm signal (for example, an acoustic signal or a notice transmitted to a predetermined address through a wireless connection) in the event of a malfunction and/or in the absence of ink and/or in the absence of paper.

In an example embodiment, the printer is configured to deliver a sum of money equivalent to the economic value of the at least one selected product or service after receiving the purchase data.

Also defined according to this description is a method for purchasing and paying for a product or service comprising the following steps:
connecting a portable electronic device to a remote server having a database containing descriptive data representing a product or service, and price data representing an economic value associated with corresponding products or services;
selecting at least one product or service from a list defined by the descriptive data and the price data;
electronically paying for the at least one selected product or service through a remote communication between the portable electronic device and a virtual cash deposit (for example an electronic wallet);
by means of the server, generating purchase data representing the product or service and the economic value thereof and transmitting the purchase data to the portable electronic device;
establishing a wireless communication between the portable electronic device and a printer equipped with a processor;
transferring the purchase data from the portable electronic device to the printer through the wireless communication;
by means of the printer, processing the purchase data and generating a proof of purchase of the product or service paid for.

Preferably, the paying step follows the step of transferring the purchase data to the printer. Still more preferably, the paying step immediately follows, or is substantially simultaneous with, the step of transferring the purchase data to the printer.

In an example embodiment, the step of generating purchase data comprises a step of generating an encrypted code which is recognizable by an optical reader of the printer and which represents the purchase data. In an example embodiment, the step of generating the proof of purchase comprises a step of printing a hard copy of the proof of purchase.

Preferably, the method comprises a step of generating an error signal in response to a malfunction or to a paper out and/or ink out signal from the printer.

In an example embodiment, the method comprises the following further steps:
registering a business in the database;
entering in the database the descriptive and price data relating to the products offered for sale by the business;
entering bank data representing a bank current account number of the business;
entering geographical location data representing at least one place where the selected product or service can be collected or delivered;
by means of the server, updating a list of businesses presented to a user through the electronic device to allow selecting the product or service after preselecting the business.

In an example embodiment, the method comprises, after the paying step, the following further steps:
displaying on the portable device a comment interface on the electronic device to allow a purchaser to enter a review relating to the at least one selected product or service;
saving the review in the database.

In a further example embodiment, the method comprises a step of transmitting the purchase data to a second portable electronic device by means of address data supplied by a purchaser who has performed the selecting step using a first portable electronic device.

It should be noted that this invention brings several advantages. The invention allows improving the visibility of a business registered in the server and facilitating access to the products and services provided by the business.

The invention allows a purchaser to perform the selection and payment steps using a portable device, in practice reducing the operations to be carried out from the terminal (which, in this invention, is replaced by the printer) installed on the premises of the business. The purchaser need use the printer only for a very short length of time, and that is, only for the time required to transfer the purchase data from the portable device and to print the proof of purchase. This invention also allows simplifying and speeding up the work of personnel employed by the business, thereby improving the service to purchasers.

Preferably, the printer is unattended. This constitutes a considerable saving of time for business personnel and saving of resources for the business itself.

Since it involves electronic payments only, the system guarantees a higher level of precision and reliability, reducing the risks of theft, forgery (for example, counterfeit banknotes) and/or counting errors.

It should be noted that the printer may, generally speaking, be considered as a service provider appliance. The service may include printing a proof of purchase, cash dispensing or other services.

With regard to the printer (that is, the provider appliance) attention is also drawn to the following.

The printer may or may not be a fiscal printer.

In one embodiment, the printer is an unattended printer.

In one embodiment, the printer is configured to transmit outgoing data messages (automatically), for example through an internet connection (for example by a web call) or by SMS or other means.

The invention thus involves a message system integrated in the printer and in the software which controls it.

In one embodiment, the printer is programmed to automatically transmit kernel messages, warnings and error states; for example, by email, SMS or other communication system.

In one embodiment, the printer is programmed to automatically transmit the messages to a specific device, for example to the server (or to another computer or predetermined electronic appliance).

For example, if the paper in the printer is nearly out, the printer kernel sends an acknowledge to an external device (for example to the server) which (based on a parameter selected during registration of the business) alerts an operator to the problem connected with the acknowledge.

In one embodiment, the printer is connected to the outside through a standard communication protocol (TCP/IP, USB, RS232, etc.). In one embodiment, the printer has, from an operational viewpoint, a passive peripheral function. In other words, the system sends print data to the peripheral (the printer) and the latter prints them.

In one embodiment, the printer has internal logic (processors and kernel software) which controls the print jobs in queue in order to optimize them both in terms of performance and in terms of feedback messages, to communicate the printer status, the print queue status and, more in general, information regarding the print jobs that the system has directed to the peripheral (printer), as well as SW which allows the printer itself to be set up through specific interfaces.

In one embodiment, the printer has an active function, in the sense that it can poll the system (that is, the server or the mobile device) for a stream of data to be printed.

In one embodiment, the printer has its own firmware or SW kernel to poll the system (that is, the server or the mobile device) for a stream of data to be printed.

In one embodiment, the printer is equipped with its own proximity peripheral. The proximity peripheral may include a scanner for reading bar codes, QR-code, NFC or similar systems.

In one embodiment, the printer is programmed (or rather, the printer processor is programmed) to recognize the data carried by the proximity peripheral.

In one embodiment, the printer is programmed to retrieve print data from the server (thus fulfilling an active function) in response to a favourable result of recognizing such data (that is, the printer verifies that the data is suitable for delivering the service).

Thus, after verifying that the data received through its proximity peripheral are suitable, the printer activates a procedure for retrieving the print data from a predefined system.

The system and method for retrieving the print data is parameterized within the printer's firmware or kernel or, in any case, is a data item stored in the printer itself.

Retrieval of the print data thus occurs following a request of the printer itself, activated by the event of reading and recognizing the data item identified through a proximity peripheral connected to the printer itself.

It should be noted that this description provides a method for purchasing and paying for a product or service, including the following steps:
connecting a portable electronic device to a remote server having a database containing descriptive data representing a product or service, and price data representing an economic value associated with corresponding products or services;
selecting at least one product or service from a list defined by the descriptive data and the price data;
electronically paying for the at least one selected product or service through a remote communication between the portable electronic device and a virtual cash deposit;
by means of the server, generating purchase data representing the type and economic value of the at least one selected product or service and transmitting the purchase data to the portable electronic device;
establishing a wireless communication between the portable electronic device and a service provider appliance equipped with a processor;
transferring the purchase data from the portable electronic device to the provider appliance through the wireless communication;
by means of the provider appliance, processing the purchase data and delivering a service.

The service may include generating a proof of purchase of the product or service paid for. In this case, the provider appliance is a printer proper, having one or more of the features described in this description.

The service may include cash dispensing. In this case, the provider appliance (that is, the printer, using the term “printer” in a broad sense) may be an automated teller machine or a money changer.

In one embodiment, the automated teller machine is equipped with an industrial PC.

The term “money changer” is used to mean an automatic dispenser of cash or services. One example of a money changer is an appliance found at a car wash which receives cash and activates a washing system, (thereby delivering a service which consists of washing a car). Another example of a money changer is an appliance which accepts cash in the form of banknotes or of a debit or credit card and returns the cash in the form of coins.

In one embodiment, the money changer has EPROM-resident firmware.

Whatever the case, the provider appliance has a firmware (implemented via hardware) or a kernel (implemented via software in the case of a PC or other appliance which already has an operating system) programmed to perform the following actions:
recognizing the purchase data (by means of a trigger event) through a wireless communication (QR code, NFC, MFT or other);
recognizing the proximity peripheral (mobile phone or sheet of paper on which the data appears);
retrieving the purchase data, which are decrypted and read;
delivering the service, preferably printing a (cash register) receipt and/or dispensing cash or activating predetermined functions (for example, washing a car or releasing a trolley and so on).

The system (method) also allows cash to be deposited, in addition to being withdrawn.

The system (method) allows a first person (for example a child) to book a product or service and request that payment be effected by a second person (for example, a parent). The second person has the option of refusing or accepting to pay for the specific product or service selected by the first person. If the second person chooses to accept the request for payment (for the product or service), the QR code is generated in response to the option chosen and is sent to the person making the request.

It should be noted that this description provides a system for purchasing and paying for a product or service, comprising:
a server having a database which is accessible through a remote connection and which contains descriptive data representing at least one product or service, and price data representing an economic value of the at least one product or service;
a portable electronic device comprising a processor, a screen and a data entry interface and configured to access the database and to select at least one product or service and to receive purchase data representing the product and the economic value of the at least one selected product or service;
a service provider appliance equipped with a processor.

The provider appliance is configured to receive and process the purchase data. In one embodiment, the provider appliance is configured to receive the purchase data through a wireless connection to the electronic device.

In one embodiment, the provider appliance is equipped with a proximity peripheral. The proximity peripheral may include a scanner for reading bar codes, QR-code, NFC or similar systems (according to what is described above with regard to the printer; it should be noted that all the features described above in connection with the printer are also applicable to the provider appliance).

In effect, in a possible embodiment, the provider appliance is (or includes) a printer configured to print a proof of purchase relating to the at least one product or service.

In one embodiment, the provider appliance is configured to dispense cash. For example, the provider appliance might be an automated teller machine (that is to say, the appliance provided by a bank to allow customers to withdraw or deposit cash without going to a human teller inside the bank).

In one embodiment, the provider appliance is or includes a money changer (having one or more of the features described above).

It should be noted that this description provides a service provider appliance.

The provider appliance includes a processor, a memory unit and a proximity peripheral for receiving purchase data (according to one or more of the features described herein). In one embodiment, the provider appliance also has a wireless connection to the Internet, to connect up to a remote server.

The provider appliance is configured to deliver a service which, depending on the application, may include printing a proof of purchase (for example a cash register receipt), dispensing cash or activating a system (for example, automatic car wash or release of a trolley or other).

The provider appliance is configured to receive the purchase data through the proximity peripheral. The provider appliance is also programmed to process the purchase data to verify the person who has made the purchase and to verify the data.

The provider appliance is programmed to deliver a service in response to (and as a function of) the processing and verification of the purchase data. In one embodiment, the provider appliance is configured to retrieve print data to be entered into a proof of purchase document (which is printed or made available in a different way).

As regards the server and, more in general, the Web portal made available by the system according to this description, attention is also drawn to the following.

Through the system, users can view the preferences of other users if the other users have opted to share their preferences (for example, favourite dishes, favourite restaurants or any other product/service advertised in the system).

The server is programmed to let the user select a preference. The server is programmed to open the Web page corresponding to the preferred product/service/business establishment in response to such selection.

The server is programmed to define a rating for a product or service so that the number of preferences selected by the other users generates (or updates) the rating. The rating assigns a value to the user for subsequent displays. In effect, the server is programmed to display the user and/or the preferences in descending order as a function of the rating, that is, those with the highest ratings will be high up in the lists displayed.

The server is programmed to let the user notify his/her product or service preference to another user through a message system.

The server is programmed to let users set as favourites also the names of other users, so as to be able to quickly view the preferences of favourite users, with the possibility of profiling the lists: for example, family, friends, colleagues or other.

The server is programmed to automatically detect the user's geographical position, if the user accepts to share that geographical position by confirming a recognition code in the system. The server is programmed to automatically make this available to other users, which may be all users or favourite users only.

The server is programmed to let users also share photos or images connected with that position, at the user's discretion.

The server is programmed to allow a user to purchase a multiple product and/or service which can be delivered on two or more occasions. In other words, the server is programmed to generate, in response to a single purchase and/or booking transaction, different codes (that is, purchase data inclusive of different QR codes or the like, representing different products or services or portions of a single product or service. These codes represent individually consumable portions and are recognized by the system as distinct parts. This makes it possible to purchase a product and/or a service on a pay-per-use basis in a single transaction. For example, if the user buys ten face massage sessions, the server generates ten codes which can be used individually (selectively) by the user on different occasions.

In one embodiment, for special purchases and/or bookings, users can also use a fingerprint reader to validate the (encrypted) code associated with the purchase data.

In one embodiment, a tool of automatic customer retention is provided which allows setting rules for granting discounts, vouchers, coupons and gifts to be dispensed automatically, at the discretion of the tradesperson, when the code is confirmed. In this embodiment, these rules are stored in the server's memory and the server is programmed to implement them.

In one embodiment, the server is programmed to grant a reward (a voucher or other form of recompense) to a first user in response to a booking and/or purchase made by a second user in connection with a product or service or business establishment (shop, restaurant, or the like) previously notified as a favourite by the first user.

In one embodiment, the server is programmed to let the user associate an image and/or message when booking/purchasing a product and/or a service.

The server is programmed to include the image and/or message in the print data transferred to the printer in response to the interaction of the printer with the mobile device.

Thus, the image and/or message will be printed by the printer (when the code is validated by the printer).

In one embodiment, the server is programmed to allow system users who are also tradespeople (for example, they run shops or restaurants or the like) to include advertising relating to events regarding their business establishments and/or shops).

The server is programmed to automatically transmit notices relating to such advertising to users who make bookings and/or purchases in the business establishment and/or shop, provided always that the users have previously granted their authorization to receive advertising, marketing or other promotional messages.

The server is programmed to include such promotional messages in the print data transferred to the printer in response to the interaction of the printer with the mobile device.

Thus, the promotional messages will be printed by the printer (when the code is validated by the printer).

### BRIEF DESCRIPTION OF THE DRAWINGS

These and other features of the invention will become more apparent from the following detailed description of a preferred, non-limiting embodiment, with reference to the single accompanying drawing which schematically represents the system according to this description.

### DETAILED DESCRIPTION OF PREFERRED EMBODIMENTS OF THE INVENTION

With reference to the accompanying drawing, the numeral 1 denotes a system according to this description, for purchasing and paying for a product or service.

In particular, the system 1 comprises a server 2 having a database which is accessible through a remote connection and which contains descriptive data representing at least one product or service, and price data representing an economic value of the at least one product or service.

The system comprises an electronic device 3 having a processor, a screen and a data entry interface. The electronic device 3 is preferably portable (for example, a smartphone or a tablet). The electronic device 3 is configured to establish a remote connection to the server 2 and to access the database to allow a user 5 (or purchaser 5) to select at least one product or service. In other words, a (potential) purchaser 5 of a product or service contained in a database is able to select the product or service through the electronic device 3.

The server is configured to generate purchase data representing the product (or service) selected and the economic value thereof and to transmit them to the electronic device 3. The electronic device 3 is configured to receive the purchase data.

The system also comprises a printer 4 having a processor and configured to print a proof of purchase relating to the at least one selected product or service. According to the invention, the printer 4 is configured to receive the purchase data through a wireless connection to the portable device 3.

It should be noted that the printer may, generally speaking, be considered as a service provider appliance. The service may include printing a proof of purchase, cash dispensing or other services. Hereinafter, for convenience of description, the provider appliance is referred to as “printer”.

In an example embodiment, the wireless connection is one or more of the following options:
a Wi-Fi connection;
a Near-Field Communication connection;
a Bluetooth connection;
an infrared connection.

In a further example embodiment, the purchase data comprise an encrypted code. For example, the purchase data comprise a bar code or a QR code. The printer 4 comprises an optical reader 4A configured to recognize the encrypted code and to receive the purchase data.

In an example embodiment, the printer 4 is configured to print a hard copy of the proof of purchase. Preferably, the proof of purchase is made accessible to the purchaser 5 through an issuing slot 4B. In an example embodiment, the printer is configured to generate an alarm signal (for example, an acoustic signal or a notice transmitted through a wireless connection to the personnel of a business) in the event of a malfunction and/or in the absence of ink and/or in the absence of paper.

In an example embodiment, the printer 4 is configured to deliver a sum of money equivalent to the economic value of the at least one selected product or service after receiving the purchase data.

In an example embodiment, the server 2 is configured to update the database when a new business is registered. The updated database comprises:
descriptive and price data relating to the products offered for sale by the business;
bank data representing a bank current account number of the business;
geographical location data representing a place where the selected product or service can be collected or delivered.

In a preferred embodiment, the database is divided into businesses to which a plurality of points of sale correspond (each associated with a place where the product or service can be collected or delivered). Preferably, for each point of sale, the database presents a plurality of products of services which can be selected using the electronic device 3.

In an example embodiment, the server 2 is configured to update the database when a new purchaser 5 is registered. The updated database comprises:
identification data of the purchaser 5 (for example a user name and a password)
payment data representing a payment method preferred by the purchaser 5 (for example, credit card, prepaid card or electronic wallet, charge to phone account).

Preferably, the database also contains preference data representing a type of product preferred by the purchaser 5 or a product previously displayed or selected by the purchaser 5.

In an example embodiment, for each purchaser 5, the database is structured to define fields relating to one or more information items regarding the purchaser 5:
gender,
address;
age;
VAT number;
tax code

Preferably, if the purchaser 5 has selected an electronic wallet payment method, the amount of the product or service selected by the purchaser 5 is not debited by the system 1 until the moment the purchase data is received (through the wireless connection to the portable device 3).

In a further example embodiment, if the purchaser 5 has selected a credit card payment method, the amount of the product or service selected by the purchaser 5 is debited by the system 1 the moment the product or service is selected.

Below is a description of how the system 1 operates.

The purchaser 5 accesses the database of the server 2 through the electronic device 3. The system is configured to recognize the purchaser 5 through the purchaser's identification data stored in the database.

The purchaser 5 selects the business (and, if necessary, the point of sale) where the purchase is to be made. The purchaser 5 finds and selects at least one product or service offered by the business and contained in the database.

The system 1 is configured to store, in a division of the database associated with the purchaser 5, preferred product lists which can be reused quickly and easily.

Once the selection of at least one product or service is confirmed, the system 1 allows the purchaser 5 to select a payment method. The system 1 generates purchase data representing the product (or service) selected and the economic value thereof (for example a bar code or a QR code). The purchase data are made available on the electronic device 3.

To validate a purchase and print a proof of purchase (for example, a receipt or an invoice), the purchaser goes to a printer 4 on the premises of the business (or point of sale of the business) selected from the database (through the electronic device 3). In an example embodiment, the electronic device 3 transmits the purchase data through a wireless connection (for example, Wi-Fi, Bluetooth, Near Field Communication or infrared). In a further example embodiment, the purchase data comprise an encrypted code (for example, a bar code or a QR code). Preferably, the printer 4 comprises an optical reader 4A configured to recognize the encrypted code and to transmit the purchase data acquired from the electronic device 3 to the printer 4.

In an example embodiment, the printer 4 is configured to connect up to the server 2 and to validate the purchase data. The server 2 transmits to the printer 4 the descriptive and price data of the selected products or services. Next, the printer 4 prints a proof of purchase corresponding to the purchase data and entitling the purchaser 5 to receive the selected product or service. If the result of validation is negative, the server 2 is configured to send to the printer an error code which is printed and/or displayed by the printer 4 (for example on a screen).

Preferably, the server 2 is configured to store the purchase data and to generate a purchase history. Still more preferably, the database is structured to contain a purchase history associated with each purchaser 5 registered on the server 2 of the system 1. Preferably, a registered purchaser 5 is entitled (following an identification procedure) to access the database of the server 2 through the electronic device 3 and to view his/her purchase history.

In an example embodiment, a first (registered) purchaser has the option of giving a product or service selected from the database of the server 2 to a second (preferably registered) purchaser as a present. The first purchaser selects from the database of the server 2 the product or service he/she intends giving to the second purchaser and receives corresponding purchase data. The first purchaser transmits the purchase data to the second purchaser (preferably through the respective electronic devices 3: for example, smartphones or tablets). The second purchaser goes to the business premises where the product can be collected (or where the service is provided) and transmits the purchase data to the printer 4, which prints the proof of purchase.

Preferably, if the first purchaser has selected an electronic wallet payment method, the economic value of the selected product (given as present to the second purchaser) is debited to the first purchaser the moment the purchase data are transmitted from the electronic device of the second purchaser to the printer 4. The second purchaser uses the proof of purchase to receive the product or the service selected by the first purchaser.

Preferably, the system 1 is configured to send a notice (for example a message) to the first purchaser the moment the purchase data are transmitted from the electronic device of the second purchaser to the printer 4.

In an example embodiment, the system is configured to enable the second purchaser to convert the purchase data relating to the first product into purchase data relating to a second product (selected by the second purchaser).

In an example embodiment, the database is structured to contain reviews corresponding to products purchased by the purchaser 5. Preferably, the electronic device 3 of the purchaser 5 is configured to access the database and to allow a review to be entered and stored in the database by means of a comment interface.

Preferably, the purchaser 5 is enabled to access the database to store a review regarding a product or service purchased only after having transmitted the purchase data from the electronic device 3 to the printer 4. In an example embodiment, the printer 4 is configured to dispense cash (that is to say, it is an automated teller machine). The purchase data sent by the server 2 to the portable device 3 represent a sum of money the purchaser 5 intends to withdraw from the automated teller machine. The automated teller machine is configured to receive the purchase data transmitted by the electronic device 3 and to dispense that sum of money.

In an example embodiment, a first (registered) purchaser has the option of sending a sum of money to a second (preferably registered) purchaser. The first purchaser (preferably through the electronic device 3) decides the sum of money and communicates it to the server 2 which generates corresponding purchase data (for example a bar code or a QR code) representing the economic value of that sum of money. The first purchaser transmits the purchase data to the second purchaser (preferably through the respective electronic devices 3: for example, smartphones or tablets). The second purchaser goes to an automated teller machine forming part of the system 1 and transmits the purchase data to the automated teller machine (for example using an optical reader the automated teller machine is equipped with) which dispenses the cash.

Preferably, the system 1 is configured to enable the purchase data to be transferred from the electronic device of the second purchaser to the automated teller machine through an access code (preferably transmitted by the server 2 to the first purchaser, who in turn transmits it to the second purchaser). It should be noted that the second purchaser might be a credit institution, that is to say, a bank.

Thus, in one possible embodiment, a (registered) user can send a sum of money to a bank through the system according to this description, thereby making a cash deposit.

It should be noted that this description also defines a method for purchasing and paying for a product or service comprising the following steps:
connecting a portable electronic device 3 to a remote server 2 having a database containing descriptive data representing a product or service, and price data representing an economic value associated with corresponding products or services;
selecting at least one product or service from a list defined by the descriptive data and the price data;
electronically paying for the at least one selected product or service through a remote communication between the portable electronic device 3 and a virtual cash deposit (for example an electronic wallet);
by means of the server 2, generating purchase data representing the product or service and the economic value thereof and transmitting the purchase data to the portable electronic device 3;
establishing a wireless communication between the portable electronic device 3 and a printer 4 equipped with a processor;
transferring the purchase data from the portable electronic device 3 to the printer 4 through the wireless communication;
by means of the printer 4, processing the purchase data and generating a proof of purchase of the product or service paid for.

Preferably, the paying step follows the step of transferring the purchase data to the printer. Still more preferably, the paying step immediately follows, or is substantially simultaneous with, the step of transferring the purchase data to the printer 4.

In an example embodiment, the step of generating purchase data comprises a step of generating an encrypted code which is recognizable by an optical reader 4A of the printer 4 and which represents the purchase data.

In an example embodiment, the step of generating the proof of purchase comprises a step of printing a hard copy of the proof of purchase. Preferably, the method comprises a step of generating an error signal in response to a malfunction or to a paper out and/or ink out signal from the printer 4.

In an example embodiment, the method comprises the following further steps:
registering a business in the database;
entering in the database the descriptive and price data relating to the products offered for sale by the business;
entering bank data representing a bank current account number of the business;
entering geographical location data representing at least one place where the selected product or service can be collected or delivered;
by means of the server 2, updating a list of businesses presented to a user through the electronic device 3 to allow selecting the product or service after preselecting the business.

In an example embodiment, the method comprises, after the paying step, the following further steps:
displaying on the portable device a comment interface on the electronic device to allow a purchaser to enter a review relating to the at least one selected product or service;
saving the review in the database.

In a further example embodiment, the method comprises a step of transmitting the purchase data to a second portable electronic device by means of address data supplied by a purchaser who has performed the selecting step using a first portable electronic device.

In an example embodiment, the step of processing the purchase data comprises a step of:
connecting up to the database and retrieving the product and price data relating to the selected product or service.

In an example embodiment, the method comprises the following further steps:
registering a purchaser 5 in the database;
entering and saving identification data of the purchaser 5 in the database;
entering payment data representing a preferred payment method;
by means of the server 2, authenticating the purchaser 5 to allow access to the database.

Preferably, the method comprises a step of saving payment data to the database and creating a payment history of a registered purchaser 5.

It should be noted that the electronic device 3 is configured to perform the following steps:
connecting up to the server 2 having the database;
searching the database of businesses and related products or services;
selecting a payment method;
receiving purchase data from the server 2;
transmitting the purchase data to the printer 4.

Preferably, the electronic device 3 is configured to perform one or more of the following steps:
authenticating (that is, logging in) a purchaser 5;
registering a purchaser 5 on the server;
entering information about the purchaser 5 in the database (for example, gender, address, age, VAT number, tax code);
selecting a business and at least one product or service;
transmitting the purchase data to a second electronic device;
entering in the database a review about a product purchased.

This description provides a computer program configured to perform the above mentioned steps when run on the processor of the electronic device 3.

It should be noted that the server 2 is configured to perform the following steps:
generating purchase data (preferably encrypted) after a product or service contained in the database has been selected by a purchaser 5;
transmitting the purchase data to the electronic device 3.

Preferably, the server 2 is also configured to perform one or more of the following steps:
transmitting descriptive and price data to the printer 4;
structuring the database;
creating and managing a register of businesses;
creating and managing a register of purchasers;
creating and managing a history of purchases (preferably associated with each purchaser 5);
creating and managing a register of reviews.

This description provides a computer program configured to perform the above mentioned steps when run on the server 2.

It should be noted that the printer 4 is configured to perform the following steps:
receiving the purchase data from the electronic device 3.
printing the proof of purchase relating to the product or service purchased.

Preferably, the printer is also configured to perform one or more of the following steps:
connecting up to the server 2 to validate the purchase data;
generating an alarm signal as a result of malfunctions or a paper out and/or ink out signal.

This description provides a computer program configured to perform the above mentioned steps when run on the processor of the printer 4.

1-13. (canceled)

14. A computer-implemented method comprising:
with a server system in communication with a database stored in a memory, engaging a remote portable electronic device over a wireless connection, the database containing descriptive data representing one or more available products or services, and price data representing an economic value associated with each of the available products or services;
receiving a selection of a selected product or service from a list of the available products or services, the list being defined by the descriptive data and the price data;
receiving, with the server system, an indication that electronic payment has been submitted for the selected product or service through a remote communication between the portable electronic device and a virtual cash deposit;
with the server system, generating purchase data representing the selected product or service and the economic value of the selected product or service, and transmitting the generated purchase data to the portable electronic device over the wireless connection, wherein the generated purchase data transmitted by the server system includes content that, in response to being transferred during a wireless communication by the portable electronic device to a printer equipped with a processor, results in the printer processing the generated purchase data and generating a proof of purchase of the product or service paid for.

15. The method according to claim 14, wherein the indication that electronic payment has been received is received by the server system after the generated purchase data is transferred to the printer.

16. The method according to claim 15, wherein the indication that the electronic payment has been submitted is received by the server system substantially simultaneously with the generated purchase data being transferred to the printer.

17. The method according to claim 14, wherein generating the purchase data comprises generating an encrypted code that is recognizable by an optical reader of the printer, wherein the generated encrypted code represents the generated purchase data.

18. The method according to claim 14, wherein generating the proof of purchase comprises printing a hard copy of the proof of purchase, and wherein the method further comprises generating an error signal in response to at least one of: a malfunction of the printer, a paper out signal transmitted by the printer, and an ink out signal transmitted by the printer.

19. The method according to claim 14 further comprising:
registering a business in the database;
entering in the database the descriptive and price data relating to the available products or services offered for sale by the business;
entering bank data representing a bank current account number of the business;
entering geographical location data representing a place where the selected product or service can be collected or delivered; and
updating a list of businesses presented to a user through the electronic device to allow the selected product or service to be selected after preselecting the business.

20. The method according to claim 14, further comprising, after receiving the indication that electronic payment has been submitted:
receiving, over the wireless connection, a review relating to the selected product or service entered by a purchaser into a comment interface displayed by the portable electronic device; and
saving the received review in the database.

21. The method according to claim 14 further comprising: with the server system, transmitting the generated purchase data to a second portable electronic device corresponding to address data supplied by a first purchaser who submitted the selection of the selected product or service received by the server system using the portable electronic device.

22. A computing system comprising:
a server system operatively connected to access a database stored by a memory through a remote connection, the database comprising descriptive data representing a plurality of available products or services, and price data representing an economic value associated with each of the plurality of available products or services;
a portable electronic device comprising a processor, a screen and a data entry interface, the portable electronic device being configured to access the database and to make a selection of a selected product or service from the database, and receive purchase data transmitted by the server system, wherein the purchase data represents the selected product or service and the economic value of the selected product or service; and
a printer comprising a processor and configured to print a proof of purchase relating to the selected product or service, wherein
the printer communicates with the portable electronic device over a wireless connection, and the printer is configured to receive the purchase data transferred between the server system and the portable electronic device through the wireless connection between the portable electronic device and the printer.

23. The system according to claim 22, wherein the remote connection is one or more of:
a Wi-Fi connection;
a Near-Field Communication connection;
a Bluetooth connection;
an infrared connection.

24. The system according to claim 22, wherein the purchase data comprises an encrypted code and wherein the printer comprises an optical reader configured to recognize the encrypted code and to receive the purchase data in response to recognizing the encrypted code.

25. The system according to claim 22, wherein the printer is configured to generate an alarm signal in response to: a malfunction, an absence of ink from the printer, and/or an absence of paper.

26. The system according to claim 22, wherein the printer is configured to deliver a sum of money equivalent to the economic value of the selected product or service after receiving the purchase data.
